(19) United States
(12) Patent Application Publication
(10) Pub. No.: US 2003/0200923 A1
(43) Pub. Date: Oct. 30, 2003

(54) Core oil and fragrance addition apparatus and method

(75) Inventors: Teresa Marie Kaufman, Neenah, WI (US); Elizabeth Emma Metz, Greenville, WI (US); Grant Vern Famuliner, Jenks, OK (US); Jeffrey Alan Warren, Broken Arrow, OK (US); Scott Edward Nelson, Appleton, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 10/135,874

(22) Filed: Apr. 30, 2002

(51) Int. Cl. B05C 1/00

(52) U.S. Cl. 118/674; 118/200; 118/684

(57) ABSTRACT

An apparatus and a method for applying a substance to a web is provided. The apparatus includes a substance and a valve for dispensing a known amount of substance from the valve. A substance supply is in communication with the valve for supplying the substance to the valve. A fluid pressure source is present and is in communication with the valve. The fluid pressure source delivers fluid pressure to the valve to actuate the valve in order to dispense a known amount of the substance from the valve. Also, the valve dispenses the substance at a rate in response to the speed of the web so that a substantially uniform amount of the substance is applied to the web.

### BACKGROUND

Paper products such as paper towels, toilet paper, and the like are commonly formed by having the paper product being wound around a core. The core may be a tube made of cardboard. In addition, cores are sometimes constructed of two webs of inexpensive kraft-type paper. When constructed out of two webs, one of the webs is spirally wrapped around a mandrel in a first direction. The second web has glue applied thereon and is spirally wrapped around the mandrel in the same direction. The glue applied to the second web is used to adhere the first and second webs to one another. The second web, that being the one having the glue initially applied, does not contact the mandrel. As such, the inner surface of the core is formed by the first web.

In order to prevent the web which contacts the mandrel from adhering to the mandrel, the web is typically treated with a substance that prevents the web from sticking to the mandrel. This substance is commonly known in the art as an oil. Therefore, as used herein the term “oil” is defined to be a substance that is applied to a web. In most cases, the oil is typically a liquid. The oil is applied to the web so that the resulting core formed by the web will not adhere to the mandrel. In addition, the oil may also be used to reduce friction and subsequent heat buildup resulting from friction between the two contacting webs that form the core. Although described as being a substance which reduces friction between the core and mandrel, and also between the two contacting webs, it is to be understood that in the present application the term “oil” is broad enough to cover any substance that is applied to a web. This substance may be a liquid or otherwise.

In addition, it is also known to form a core out of a single web as opposed to two webs that contact one another. Additionally, if formed out of a single web, it is sometimes the case that oil is applied to the inner surface of the core in order to prevent the core from adhering to the mandrel onto which the core is formed.

It is also known in the art to incorporate a fragrance into the oil that is applied to the web. In certain instances, the fragrance may be oil based and may be soluble in the particular oil that is applied to the web. The fragrance may be added to the web in order to mask the odor of the web and the glue which form the core. Additionally, the fragrance may be used so that it provides a pleasant smell to the resulting paper product. Additionally, fragrance may be added to the web in order to be strong enough to provide a desired odor to the room into which the rolled product is placed.

Current systems are in use that are capable of applying an oil to a web. These systems may be either gravity fed or pressurized and incorporate needle valves that are adjusted by an operator by hand. In order to set the amount of oil that is added to the web, the operator may adjust the system by counting the number of drips per minute viewed through a sight glass. Once the desired amount of oil has been achieved, the operator may simply let the machine run at this rate. Such gravity fed and pressurized systems shut off automatically when the core building machine is turned off. A problem with this type of arrangement is that the amount of oil added may be arbitrary and subject to human error. Additionally, these types of systems will not adjust the amount of oil that is added to the web in order to deliver more or less oil when the speed of the web increases or decreases.

In the current system, the operator may adjust the needle valve as needed in order to compensate for the speed of the web such that a desired amount of oil is applied to the web. As can be expected, if the same amount of oil were applied to the web and the speed of the web changed, more or less oil would be applied to the web than was initially desired. Obviously, such a result is undesirable.

On current machines, the speed of the web and hence the speed of building of the core is currently a manual adjustment and may be adjusted hourly by a user. Present systems are incapable of adjusting the amount of oil that is added to the web as the speed of the web changes.

The present invention improves upon previous apparatuses and methods of applying oil to a web by providing an apparatus and a method where the oil is applied to the web in response to the speed of the web such that a substantially uniform amount of oil is applied to the web.

### SUMMARY

Various features and advantages of the invention will be set forth in part in the following description, or may be obvious from the description, or may be learned from practice of the present invention.

The present invention provides for an apparatus for applying a substance to a web. The apparatus includes the substance and a valve for dispensing a known amount of the substance from the valve. A substance supply is also present and is in communication with the valve for supplying the substance to the valve. A fluid pressure source is also provided and is in communication with the valve. The fluid pressure source delivers fluid pressure to the valve in order to actuate the valve and dispense a known amount of the substance from the valve. The valve dispenses a substance at a rate in response to the speed of the web so that a substantially uniform amount of the substance is applied to the web.

The present invention also includes an exemplary embodiment of the apparatus as previously discussed where the substance is an oil that has a fragrance added thereto. Additionally, the substance supply is a pressurized oil system that has an oil reservoir. A regulator regulates an air supply to the oil reservoir in order to cause the pressurized oil system to be at a desired pressure.

An additional exemplary embodiment of the present invention exists in an apparatus as previously discussed where the web is a material that is used to form a core of a rolled product.

Additionally, an exemplary embodiment exists in an apparatus as previously discussed where the oil prevents the web from adhering to a mandrel as the web is wound onto the mandrel. Also, the substance reduces friction between the web and a second web that engages the web.

An additional exemplary embodiment of the present invention resides in an apparatus as previously discussed which further has an oil manifold. The oil manifold is in communication with the valve and receives the substance from the valve. The oil manifold is configured for applying a substantially uniform amount of the substance to the web.

A further exemplary embodiment of the present invention exists in an apparatus as previously discussed which further has a felt member. The felt member is configured for receiving the substance from the oil manifold. The web engages the felt member and the substance is transferred from the felt member to the web in a uniform amount.

A further exemplary embodiment exists in an apparatus as previously discussed where the fluid in the fluid pressure source is air. The fluid pressure source supplies air pressure to the valve in order to actuate the valve.

The present invention also provides for a method of applying a substance to a web. The method includes the step of providing a moving web along with monitoring the speed of the moving web. A valve is provided for dispensing a known amount of the substance from the valve. Additionally, the substance is supplied to the valve along with a fluid pressure. The substance is dispensed from the valve so that the substance is applied to the web. Additionally, the dispensing of the substance is controlled so that the valve dispenses the substance at a rate in response to the speed of the web. This dispensing occurs such that a substantially uniform amount of the substance is applied to the web.

An additional exemplary embodiment of the present invention exists in a method as previously discussed where the substance is an oil that has a fragrance added thereto.

A still further exemplary embodiment resides in a method as previously discussed which has the further step of turning the web onto a mandrel. This is done in order to form a core of a rolled product. Additionally, it may be the case that in another exemplary embodiment, a second web may be applied to the web in order to form the core of the rolled product.

The present invention also provides for a method of applying a substantially uniform amount of an oil that has a fragrance to a web. The web is used to form a core of a rolled product. The method includes the steps of supplying the pressurized oil that has a fragrance to a valve. Additionally, air pressure is also supplied to the valve. The valve is actuated such that a substantially uniform amount of the oil is dispensed from the valve. The dispensed oil is applied substantially uniformly to a moving web. The actuation of the valve is controlled such that the valve dispenses the oil at a rate in response to the speed of the web. This occurs such that a substantially uniform amount of the oil is applied to the moving web.

Also provided is a plurality of rolled products. Each of the rolled products has a core formed from at least one web. The web has a substance applied thereto so that a substantially uniform amount of the substance is applied to each of the cores in the plurality of rolled products.

### BRIEF DESCRIPTION OF THE DRAWINGS

FIG. 1 is a schematic view of an apparatus for applying a substance to a web in accordance with an exemplary embodiment of the present invention.

FIG. 2 is a front elevation view of a pressurized oil system in accordance with an exemplary embodiment of the present invention.

FIG. 3 is a side elevation view of an apparatus for applying a substance to a web in accordance with the present invention. The view shows a valve being located proximate to a moving web and configured to apply a substance to the web.

FIG. 4 is a front elevation view of the exemplary embodiment shown in FIG. 3. Here, the web can be seen moving through an oil manifold having a felt material attached thereto. The substance is applied to the web as the web passes under the felt material.

FIG. 5 is a perspective view of a mandrel engaging a pair of moving webs. The webs are wrapped around the mandrel in order to form a core.

FIG. 6 is a side elevation view of the engagement shown in FIG. 5.

FIG. 7 is a side elevation view of a core being formed on a mandrel by the winding of a pair of webs onto the mandrel.

### DETAILED DESCRIPTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

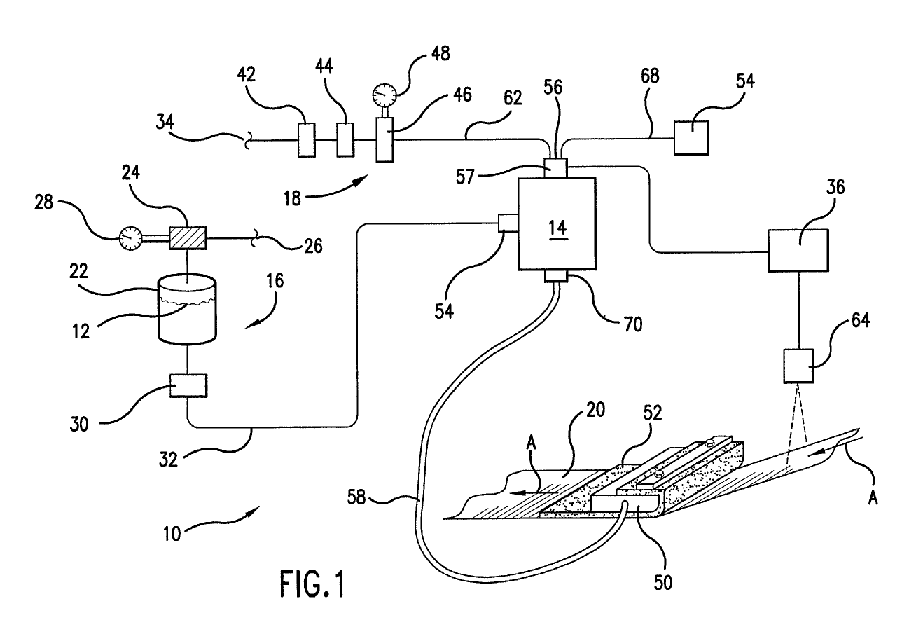

Referring now to the drawings, an apparatus 10 in accordance with an exemplary embodiment of the present invention is shown in a schematic view in FIG. 1. The apparatus 10 is capable of applying a substance 12 onto a web 20. The substance 12 may be an oil, as is known in the art, having a fragrance added thereto. In one exemplary embodiment of the present invention, the oil 12 is Witerex® 425 mineral oil lubricant which is produced by Mobil ® of 3225 Gallows Road, Fairfax, Va., USA. In addition, substance 12 may be any substance that is capable of effecting the functional chemistry of the web 20.

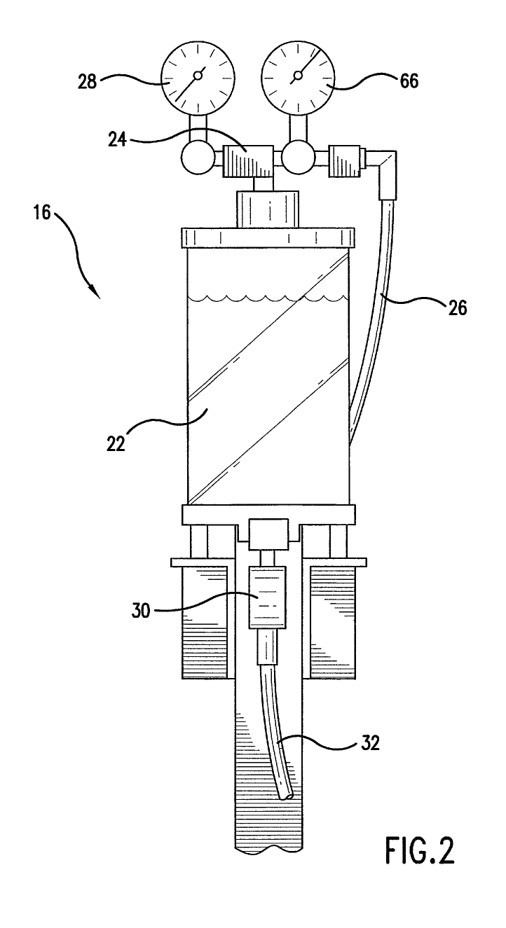

The substance or oil 12 may be contained within an oil reservoir 22 in a substance supply system 16. The substance supply system 16 may be a pressurize oil system 16 in one exemplary embodiment of the present invention. Here, the oil 12 is pressurized within the oil reservoir 22. The pressure source emanates from an air supply 26 that is in communication with the oil reservoir 22. A regulator 24 is disposed between the air supply 26 and the oil reservoir 22 and is capable of regulating the amount of air imparted onto the oil 12 in the oil reservoir 22 such that a desired pressure of the pressurized oil system 16 is achieved. The regulator 24 may be fitted with a pressure gauge 28 in order to monitor the pressure of the pressure oil system 16. Additionally, as seen in FIG. 2, an air supply pressure gauge 66 may be present in order to provide a reading of the air pressure that is supplied to the regulator 24. Although not shown in FIG. 2, a filter may be placed inside the oil reservoir 22 to filter the oil 12.

Referring back to FIG. 1, the regulator 24 may be manually or automatically adjusted as is known in the art in order to regulate the pressure of the pressurized oil system 16. Located downstream from the oil reservoir 22 is a shut off valve 30. The shut off valve 30 may be configured in order to completely prevent the flow of oil 12 from the oil reservoir 22, or may be configured to allow for a desired amount of oil 12 to flow through the shut off valve 30. The shut off valve 30 may be a solenoid actuated valve that is in the closed position when the valve 14 is off.

An arrangement of the afore-mentioned components of the pressurized oil system 16 is shown in greater detail in FIG. 2. FIG. 2 shows one exemplary embodiment of the configuration of the previously mentioned components of the pressurized oil system 16. The oil 12 may flow from the pressurized oil system 16 through tubing 32. In one exemplary embodiment of the present invention, the tubing 32 is made of a flexible material that is one-quarter inch in diameter.

Referring back to FIG. 1, the apparatus 10 also includes a valve 14. Oil 12 from the pressurized oil system 16 is supplied to the valve 14 through the tubing 32. The tubing 32 is attached to an inlet 54 of the valve 14. The valve 14 is also supplied with a fluid pressure from another source in order to provide for the actuating power of the valve 14. As seen in FIG. 1, the source of this pressure is a fluid pressure source 18. Here, the fluid is air from an air supply 34. The air from the air supply 34 may be passed through a filter 42 in order to clean dirt and other contaminants from the air. Next, the filtered air may be placed through a lubricator 44 which applies a desired amount of oil or other lubrication to the filtered air. This may be done to ensure that the air will have enough lubrication therein in order to properly function within the valve 14. Also, this may be done in order to ensure that the valve 14 is properly lubricated as the air is supplied to the valve 14.

In other exemplary embodiments of the present invention, it may not be necessary to provide a lubricator 44 into the fluid pressure source 18 in order to lubricate the air. In such instances, it may be the case that the valve 14 is of a particular construction that it does not have a need for air that is provided with lubrication. A regulator 46 is located downstream from the lubricator 44 and regulates the amount of air that is supplied by the fluid pressure source 18 such that the air is at a desired pressure. A pressure gauge 48 is in communication with the regulator 46 and allows for the proper monitoring of the pressure supplied by the fluid pressure source 18. The air is supplied from the fluid pressure source 18 through an air supply line 62.

In one exemplary embodiment of the present invention, the air pressure supplied to the pressurized oil system 16 is in the range of 20 to 30 pounds per square inch. Also, the air pressure supplied by the air supply line 62 to the valve 14 may be between 60 and 80 pounds per square inch. In one exemplary embodiment of the present invention, the air pressure supplied to the pressurized oil system 16 is 20 pounds per square inch and the air pressure supplied to the valve 14 is 80 pounds per square inch.

The valve 14 accepts air pressure from the air supply line 62 at an inlet 56. At the inlet 56, a solenoid 57 is present. The solenoid 57 may be actuated by electrical power from an electrical power source 54. The electrical power source 54 may be placed in communication with the solenoid 57 through an electrical line 68. The power from the electrical power source 54 may be actuated in order to move the solenoid 57 such that air pressure from the fluid pressure source 18 is applied to the valve 14. Shutting off power from the electrical power source 54 may deactuate the solenoid 57 and cause it to move back into its at rest position hence preventing air pressure from entering the valve 14. The solenoid 57 of the valve 14 may in one exemplary embodiment require 24 volts of DC current in order to actuate. Additionally, other ways known in the art may be employed in order to control the application of air pressure into the inlet 56, and hence control the air pressure applied to the valve 14.

The valve 14 may be constructed such that oil 12 that is supplied by the pressurized oil system 16 is present within the valve as the electrical power source 54 actuates causing the solenoid 57 to move such that air pressure is also supplied to the valve 14. In such an instance, the air pressure will cause the valve 14 to actuate such that the oil 12 is discharged from the valve 14 through a valve outlet 70. A known amount of oil 12 will then be transported through an oil supply line 58. This is because the valve 14 is constructed in such a way that a known quantity of oil 12 is present within the valve 14 before actuation. Additionally, the pressure of the pressurized oil system 16 may also help accurately determine the amount of oil 12 within the valve 14 before actuation. In one exemplary embodiment of the present invention, the valve 14 may be approximately one-half inch wide by two inches deep by four inches long. At full stroke, the valve 14 may deliver approximately 0.028 milliliters per pulse with an error ratio of +−3%.

In one exemplary embodiment of the present invention, the valve 14 is a Microshot Valve produced by Valco Cincinnati located at 411 Circle Freeway Drive, Cincinnati, Ohio 45246, USA. The model number of the Microshot Valve is DLM2213. Valve 14 may be a positive displacement metering valve. This type of valve allows for a more consistent volumetric output than a corresponding pressure regulated valve. Also, this valve allows for advantages over previously used needle valves in that the valve may be adjusted in response to the speed of the web 20. Additionally, changes in the viscosity of the oil 12 may have a negligible impact in certain circumstances upon the amount of oil 12 dispensed from the valve 14 in a valve 14 that is a positive displacement valve.

The amount of oil 12 that is discharged from the valve 14 will flow through the oil supply line 58 into an oil manifold 50. The oil manifold 50 is configured to apply a substantially uniform amount of oil 12 to a felt member 52 that is in communication with the outlet of the oil manifold 50. In some instances, the oil manifold 50 may have several outlet ports which discharge oil 12 onto the felt member 52. In other exemplary embodiments of the present invention, the oil manifold 50 may be configured with only one or two outlet ports which discharge oil 12 onto the felt member 52. The design of an oil manifold 50 that provides for an even distribution of oil 12 that is supplied to the felt member 52 is well known in the art.

Although member 52 is described as being felt, it is to be understood that various materials may be used in order to hold and transfer oil 12 to the web 20. For instance, any type of non-woven material may be used in place of the felt member 52. In other exemplary embodiments, a felt member 52 or member 52 is not necessary.

The web 20 tightly engages the felt member 52 and passes underneath the felt member 52. The felt member 52 has an even distribution of oil 12 applied thereto. Due to contact with the web 20, the oil 12 will be transferred to the web 20 in a substantially uniform amount. This allows for an application of the oil 12 onto the web 20 that is uniform throughout. However, it may be the case that in a particular application it is desirable to have an uneven distribution of oil 12 on the web 20. In such an instance, the oil manifold 50 and/or the felt member 52 may be configured accordingly. The present invention encompasses exemplary embodiments of an apparatus 10 where both an even and an uneven amount of oil 12 are applied to the web 20. Additionally, it may be the case that the felt member 52 is not present and the oil manifold 50 is configured to evenly apply oil 12 to the web 20. Design of such oil manifolds 50 are well known in the art. As such, the dispensing of the oil 12 from the valve 14 into the oil manifold 50 may be tightly controlled in order to get a consistent amount of oil 12 onto each section of the web 20. However, as stated, it may be the case that varying amounts of oil 12 are desired to be applied onto the web 20. Appropriate adjustments may be made in the apparatus 10 in order to accommodate such processes.

The web 20 moves in the direction of arrow A as indicated in FIG. 1, contacting the felt member 52 and having the oil 12 applied thereto. A sensor 64 measures the speed of the web 20. As shown in FIG. 1, the sensor 64 measures the speed of the web 20 as the oil 12 is applied. In other exemplary embodiments of the present invention, it may be the case that the sensor 64 measures the speed of the web 20 before or after the oil 12 has been applied to the web 20. In other exemplary embodiments of the present invention, the sensor 64 only detects the presence or non-presence of the web 20. The present invention encompasses exemplary embodiments where the speed of the web 20 is determined at locations other than the one disclosed in FIG. 1. Additionally, it may be the case that the speed of the web 20 is determined through a measurement of the rotation of a drive that causes movement of the web 20 instead of directly measuring the web 20 itself. The present invention encompasses other exemplary embodiments in which the speed of the web 20 is determined other than by the use of a sensor 64 to measure the web speed.

The speed of web 20 is sent into a microprocessor 36. The microprocessor 36 is configured such that a change in the speed of the web 20 causes a corresponding change in the rate of the oil 12 supplied to the oil manifold 50 and then onto felt member 52. In effect, the application of oil 12 to the web 20 will be adjusted in response to the change in speed of the web 20 so that a substantially uniform amount of oil 12 is applied to the web 20. The microprocessor 36 may control the amount of dispensing from the valve 14 by communicating with the solenoid 57. It also may be the case that the microprocessor 36 communicates with the electrical power source 54 to control the valve 14 in other exemplary embodiments of the present invention. The amount and/or rate of oil 12 supplied to the web 20 may be changed during the actual running of the apparatus 10.

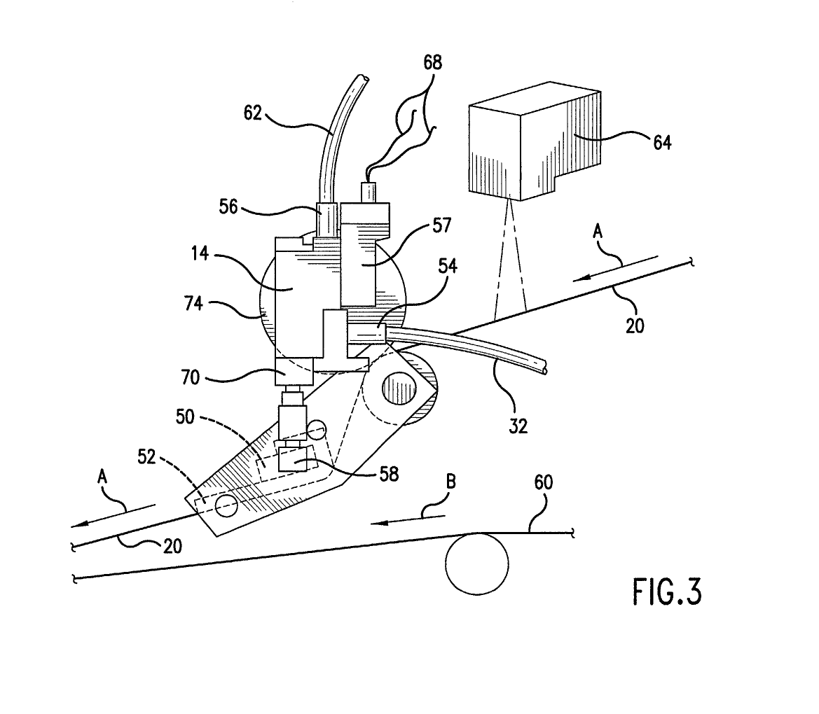

FIG. 3 shows one configuration of the valve 14. Here, the valve 14 is shown having the air pressure from the air supply line 62 being applied to the valve 14 through the inlet 56 at the top of the valve 14. The solenoid 57 is located proximate to the inlet 56. The oil 12 being sent through the tubing 32 enters the valve 14 through the inlet 54 at approximately the bottom of the valve 14. In other exemplary embodiments of the present invention, the positioning of the solenoid 57 along with the inlets 54 and 56 may be modified. FIG. 3 also shows a second web 60 being moved in a direction indicated by arrow B. The second web 60 does not have oil 12 applied thereto. Additionally, it may be the case in other exemplary embodiments of the present invention that the second web 60 is positioned above or to the side of the web 20 instead of below web 20.

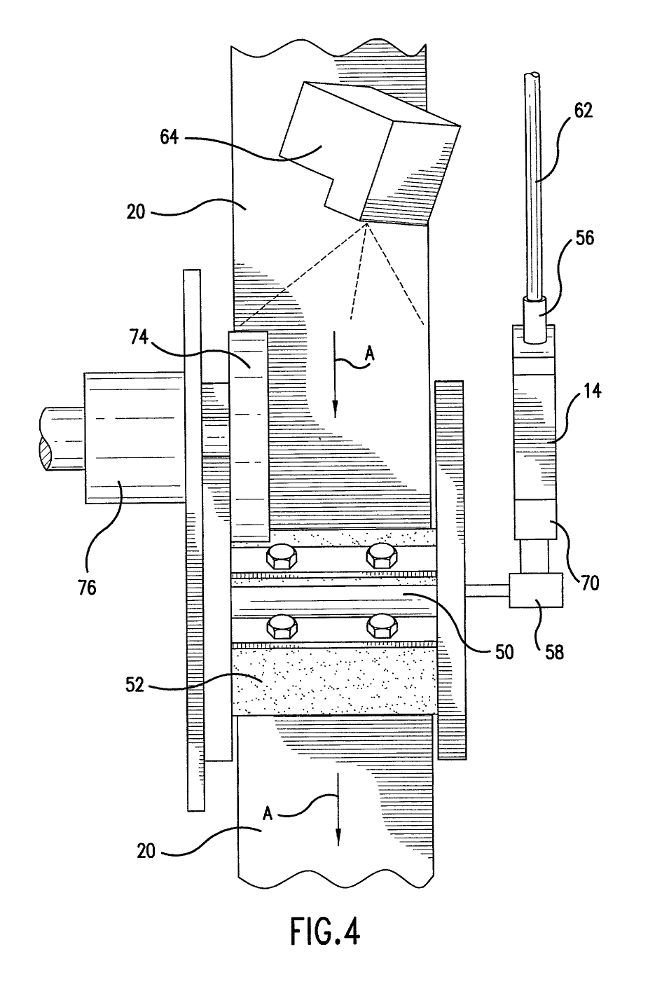

FIG. 4 shows a front view of the web 20 moving under the felt 52. The valve 14 is shown as being to the side and adjacent to the oil manifold 50. Additionally, the sensor 64 is shown being located before the web 20 engages the felt 52. A rotating roller 74 may be present in order to help measure the speed of the web 20. Additionally, the roller 74 may contact the web 20 and rotate with and/or drive the web 20 in the direction indicated by arrow A. An encoder 72 is in communication with the rotating roller 74 in order to acquire data from the roller 74 and calculate the speed of the web 20. Alternatively, the sensor 64 may be used to measure speed in other exemplary embodiments.

FIG. 5 shows the web 20 and the second web 60 engaging a mandrel 40. The mandrel 40 rotates in the direction of arrow C and draws both the web 20 and the second web 60 onto the mandrel 40.

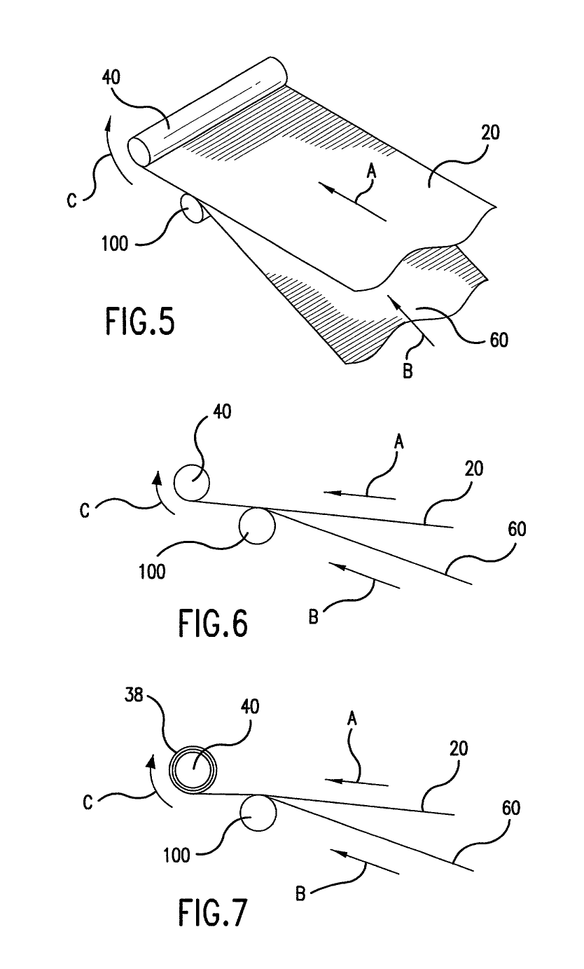

FIG. 6 is a side view of FIG. 5. Here, it can be seen that the web 20 is above the second web 60 and in contact with the mandrel 40. Web 20 contacts the mandrel 40 and the second web 60 contacts the web 20. As such, only web 20 actually touches the surface of the mandrel 40. A roll 100 may be provided in order to help urge the second web 60 against the web 20 so that they may be wrapped around the mandrel 40. In other exemplary embodiments of the present invention, other configurations or deletion of some of these parts may be used in order to wind the web 20 and/or the second web 60. Belts (not shown) may be used to effect movement of the web 20 as is commonly known in the art.

FIG. 7 shows a core 38 being formed on mandrel 40 by the rotation of the web 20 and the second web 60 onto the mandrel 40. The oil 12 that is applied to the web 20 will help prevent the web 20 from sticking to the mandrel 40. Additionally, the oil 12 prevents heat buildup due to friction between the second web 60, the web 20, and the mandrel 40. In other exemplary embodiments of the present invention, the oil 12 may be applied to both the web 20 and the second web 60. The web 20 may be spirally wrapped around the mandrel 40 in one direction, and the second web 60 spirally wrapped around the mandrel 40 as well in order to form the core 38. The second web 60 may have glue applied on the upper surface in order to adhere the second web 60 onto the web 20 to form the core 38. One advantage of the configuration of the apparatus 10 allows for a known and substantially uniform amount of oil 12 to be applied to the web 20. In one exemplary embodiment of the present invention, the valve 14 may be actuated three times per each core 38. In this exemplary embodiment, the valve 14 may deliver approximately 0.003636 milliliters per roll and may be automatically adjusted for web 20 speeds from 5 to 30 cores per minute to deliver this constant volume of oil 12. The time duration between the pulses of the valve 14 will vary with the speed of the web 20 which may in some instances be referred to as the machine speed in cores 38 per minute. The speed of the web 20 or that of the core machine speed may be calculated within the microprocessor 36.

The second web 60 may have glue applied thereto. The glue may be continuously applied to one or both sides of the second web 60. A glue applicator (not shown) may have a roller with a lower periphery immersed within a reservoir containing liquid glue. As the glue applicator turns onto the second web 60, contact therein will transfer the glue onto the second web 60. One such glue applicator that is known in the art for applying glue to a second web 60 that is used to form a core 38 of a rolled product is disclosed in U.S. Pat. No. 5,840,150.

The application of fragrance to the oil 12 allows for the masking of odor associated with the core 38 or may allow for an overall fragrance to be imparted to the resulting product. The apparatus 10 therefore allows for a uniform application of oil 12 to the inner surface of the core 38 by way of adjusting the application of the oil 12 onto the web 20 by adjusting in response to the speed of the web 20 in one exemplary embodiment of the present invention.

Due to the controlled release of the oil 12 from the valve 14, waste of the web 20 and the oil 12 will be reduced. Also, the lower friction between the mandrel 40 and the web 20, or even between the web 20, the mandrel 40, and the second web 60, may lead to increased reliability in the production of the core 38 and also increased speed of the building process. Further, the elimination of manual adjustments to existing application systems will be eliminated. Finally, controlled and measurable oil 12 additions can be imparted to the web 20 with no line to line variability.

It should be understood that the present invention includes various modifications that can be made to embodiments of the apparatus and method for the application of oil onto a web or core as come within the scope of the appended claims and their equivalents.

### EXPERIMENT CARRIED OUT ON ONE EXEMPLARY EMBODIMENT OF THE PRESENT INVENTION

An experiment was conducted in order to measure the amount of oil 12 dispensed from the valve 14 after 200 actuations of the valve 14 at different speeds of the web 20. The pressure of the pressurized oil system 16 was set at 20 pounds per square inch and the air pressure to the valve 14 from the air supply line 62 was set at 80 pounds per square inch. The valve 14 used was the Microshot Valve produced by Valco Cincinnati located at 411 Circle Freeway Drive, Cincinnati, Ohio 45246, USA. The valve 14 was adjusted to the full open position to allow for 0.028 milliliters per pulse. An actuation rate of three pulses per each of the cores 38 formed was selected. In other words, each of the cores 38 would have three pulses of oil 12 supplied from the valve 14. For each test, 200 pulses or actuations of the valve 14 were conducted. The following table lists the results obtained:

| Cores | | Actual | Theoretical | | Actual | Calculated | |
|---|---|---|---|---|---|---|---|
| per | Milliliters | Milliliters | Milliliters | Percent | Milliliters | Milliliters | Percent |
| minute | Collected | per pulse | per pulse | Accuracy | per roll | per roll | Accuracy |
| 5 | 5.3 | 0.0265 | 0.028 | 95 | 0.0036136 | 0.003636 | 99 |
| 10 | 5.4 | 0.027 | 0.028 | 96 | 0.0036818 | 0.003636 | 99 |
| 15 | 5.4 | 0.027 | 0.028 | 96 | 0.0036818 | 0.003636 | 99 |
| 20 | 5.4 | 0.027 | 0.028 | 96 | 0.0036818 | 0.003636 | 99 |
| 25 | 5.4 | 0.027 | 0.028 | 96 | 0.0036818 | 0.003636 | 99 |
| 30 | 5.5 | 0.0275 | 0.028 | 98 | 0.00375 | 0.003636 | 99 |

As can be seen, the test carried out with the stated valve 14 supplies a consistent amount of oil 12 for each core 38 that is formed regardless of the speed of web 20.

Another test was carried out where each drip contains 0.04 ml of oil and each shot of the valve 14 produced 0.028 ml/pulse. The following table lists the results obtained:

CORE MANDREL OILER/CORE FRAGRANCE ADDITION

The Rates/Volumes of Fragrance/Oil with Shot Meter System:

| | |
|---|---|
| Constants = | A) 1 drip = 0.04 ml |
| | B) @ Max Stroke Length, Valve produced 0.028 ml/pulse |

Assumptions = # of drips has been assigned for each core/minute

| Cores | Drips | ml | Pulses | | Pul- | | |
|---|---|---|---|---|---|---|---|
| per | per | per | per | Sec/ | ses/ | Pulses/ | ml/ |
| minute | minute | minute | minute | pulse | core | Roll | Roll |
| 5 | 10 | 0.40 | 14.29 | 4.20 | 2.86 | 0.12987 | 0.003636 |
| 6 | 12 | 0.48 | 17.14 | 3.50 | 2.86 | 0.12987 | 0.003636 |
| 7 | 14 | 0.56 | 20.00 | 3.00 | 2.86 | 0.12987 | 0.003636 |
| 8 | 16 | 0.64 | 22.86 | 2.63 | 2.86 | 0.12987 | 0.003636 |
| 9 | 18 | 0.72 | 25.71 | 2.33 | 2.86 | 0.12987 | 0.003636 |
| 10 | 20 | 0.80 | 28.57 | 2.10 | 2.86 | 0.12987 | 0.003636 |
| 11 | 22 | 0.88 | 31.43 | 1.91 | 2.86 | 0.12987 | 0.003636 |
| 12 | 24 | 0.96 | 34.29 | 1.75 | 2.86 | 0.12987 | 0.003636 |
| 13 | 26 | 1.04 | 37.14 | 1.62 | 2.86 | 0.12987 | 0.003636 |
| 14 | 28 | 1.12 | 40.00 | 1.50 | 2.86 | 0.12987 | 0.003636 |
| 15 | 30 | 1.20 | 42.86 | 1.40 | 2.86 | 0.12987 | 0.003636 |
| 16 | 32 | 1.28 | 45.71 | 1.31 | 2.86 | 0.12987 | 0.003636 |
| 17 | 34 | 1.36 | 48.57 | 1.24 | 2.86 | 0.12987 | 0.003636 |
| 18 | 36 | 1.44 | 51.43 | 1.17 | 2.86 | 0.12987 | 0.003636 |
| 19 | 38 | 1.52 | 54.29 | 1.11 | 2.86 | 0.12987 | 0.003636 |
| 20 | 40 | 1.60 | 57.14 | 1.05 | 2.86 | 0.12987 | 0.003636 |
| 21 | 42 | 1.68 | 60.00 | 1.00 | 2.86 | 0.12987 | 0.003636 |
| 22 | 44 | 1.76 | 62.86 | 0.95 | 2.86 | 0.12987 | 0.003636 |
| 23 | 46 | 1.84 | 65.71 | 0.91 | 2.86 | 0.12987 | 0.003636 |
| 24 | 48 | 1.92 | 68.57 | 0.88 | 2.86 | 0.12987 | 0.003636 |
| 25 | 50 | 2.00 | 71.43 | 0.84 | 2.86 | 0.12987 | 0.003636 |
| 26 | 52 | 2.08 | 74.29 | 0.81 | 2.86 | 0.12987 | 0.003636 |
| 27 | 54 | 2.16 | 77.14 | 0.78 | 2.86 | 0.12987 | 0.003636 |
| 28 | 56 | 2.24 | 80.00 | 0.75 | 2.86 | 0.12987 | 0.003636 |
| 29 | 58 | 2.32 | 82.86 | 0.72 | 2.86 | 0.12987 | 0.003636 |
| 30 | 60 | 2.40 | 85.71 | 0.70 | 2.86 | 0.12987 | 0.003636 |

As can be seen, a consistent amount of pulses per roll and ml of oil 12 per roll was obtained regardless of the number of cores formed per minute.

What is claimed is:

1. An apparatus for applying a substance to a web comprising:
a substance;
a valve for dispensing a known amount of said substance from said valve;
a substance supply in communication with said valve for supplying said substance to said valve;
a fluid pressure source in communication with said valve, said fluid pressure source delivering fluid pressure to said valve to actuate said valve to dispense a known amount of said substance from said valve; and
wherein said valve dispenses said substance at a rate in response to the speed of the web such that a substantially uniform amount of said substance is applied to the web.

2. The apparatus of claim 1, wherein:
said substance is an oil having a fragrance added thereto; and
said substance supply is a pressurized oil system having an oil reservoir, a regulator regulates an air supply to said oil reservoir to cause said pressurized oil system to be at a desired pressure.

3. The apparatus of claim 2, wherein:
said pressurized oil system has a shut-off valve being disposed between said oil reservoir and said valve, said shut-off valve configured to control the transfer of said oil to said valve.

4. The apparatus of clam 1, wherein said fluid pressure source supplies air pressure to said valve to actuate said valve.

5. The apparatus of claim 1, further comprising a microprocessor for controlling the dispensing of said valve such that said valve dispenses said substance at a rate in response to the speed of the web.

6. The apparatus of claim 1, wherein the web is a material used to form a core of a rolled product.

7. The apparatus of claim 1, wherein said substance is an oil having a fragrance added thereto, said substance preventing the web from adhering to a mandrel as the web is wound onto the mandrel, and said substance reducing friction between the web and a second web the web engages.

8. The apparatus of claim 4, wherein said fluid pressure source has a filter for cleaning the air and a lubricator for applying a lubricating oil to the air supplied to said valve.

9. The apparatus of claim 1, further comprising an oil manifold in communication with said valve and receiving said substance from said valve, said oil manifold configured for applying a substantially uniform amount of said substance to the web.

10. The apparatus of claim 9, further comprising a felt member for receiving said substance from said oil manifold, the web engages said felt member and said substance is transferred from said felt member to the web in a uniform amount.

11. The apparatus of claim 1, wherein said valve has a solenoid that is activated by electrical power to allow fluid pressure from said fluid pressure source to cause said substance to be dispensed from said valve.

12. The apparatus of claim 3, wherein the pressure of said pressurized oil system is about 10 to 30 pounds per square inch.

13. The apparatus of claim 4, wherein from about 70 to about 90 pounds per square inch of air pressure is applied to said valve.

14. The apparatus of claim 1, wherein said valve dispenses said substance at varying rates during the moving of the web and the operation of said apparatus.

15. An apparatus for applying an oil to a web comprising:
a pressurized oil system having a reservoir;
a valve into which oil from said pressurized oil system is supplied, said valve configured for dispensing a known amount of oil therefrom;
an air pressure supply for supplying air pressure to said valve, the air pressure causing said valve to actuate and dispense oil from said valve;
an oil manifold for receiving oil dispensed from said valve, said oil manifold having a felt member, said oil manifold configured such that oil is applied to said felt member and then is applied substantially uniformly to a moving web that engages said felt member of said oil manifold; and
wherein said valve dispenses the oil in response to the speed of the web such that a substantially uniform amount of oil is applied to the web.

16. The apparatus of claim 15, wherein:
said pressurized oil system has a regulator for regulating a supply of air to said reservoir to cause said pressurized oil system to be at a desired pressure; and
said pressurized oil system has a shut-off valve located downstream from said reservoir, said shut-off valve capable of controlling the flow of oil to said valve.

17. The apparatus of claim 15, further comprising a microprocessor for adjusting the dispensing of the valve in response to the speed of the web.

18. The apparatus of claim 15, wherein said valve has a solenoid that is actuated by electrical power to allow air pressure from said air pressure supply to cause the oil to be dispensed from said valve.

19. The apparatus of claim 15, wherein said valve dispenses the substance at varying rates during the moving of the web and the operation of said apparatus.

20. A method of applying a substance to a web comprising the steps of:
providing a moving web;
monitoring the speed of the moving web;
providing a valve for dispensing a known amount of the substance from said valve;
supplying the substance to said valve;
supplying a fluid pressure to said valve;
dispensing the substance from said valve so that the substance is applied to the web; and
controlling the dispensing of the substance so that said valve dispenses the substance at a rate in response to the speed of the web such that a substantially uniform amount of the substance is applied to the web.

21. The method of claim 20, wherein said substance is an oil having a fragrance added thereto.

22. The method of claim 21, wherein the step of supplying said valve with the substance is accomplished by use of a pressurized oil system having an oil reservoir and a regulator that regulates an air supply to said oil reservoir to cause said pressurized oil system to be at a desired pressure.

23. The method of claim 22, further comprising the step of regulating the supply of substance from said pressurized oil system by a shut-off valve disposed between said oil reservoir and said valve.

24. The method of claim 20, further comprising the step of turning said web onto a mandrel to form a core of a rolled product.

25. The method of claim 24, further comprising the step of applying a second web to the web in order to form the core of the rolled product.

26. A method of applying a substantially uniform amount of an oil having a fragrance to a web used to form a core of a rolled product comprising the steps of:
supplying the pressurized oil having a fragrance to a valve;
supplying air pressure to the valve;
actuating the valve such that a substantially uniform amount of the oil having a fragrance is dispensed from the valve;
applying the dispensed oil having a fragrance substantially uniformly to a moving web; and
controlling the actuation of the valve so that the valve dispenses the oil having a fragrance at a rate in response to the speed of the web such that a substantially uniform amount of the oil having a fragrance is applied to the moving web.

27. A plurality of rolled products, each of said rolled products comprising:
a core formed by at least one web, said web having a substance applied to the web such that a substantially uniform amount of said substance is applied to each of said cores in said plurality of rolled products.

28. The plurality of rolled products of claim 27, wherein said core is formed by two webs, only one of said webs having said substance applied thereto.

29. The plurality of rolled products of claim 27, wherein said substance is applied to each of said cores with a percent variation of 1% or less between each of said cores.
